(19) United States
(12) Patent Application Publication
(10) Pub. No.: US 2013/0166937 A1
(43) Pub. Date: Jun. 27, 2013

(54) UNIVERSAL SERIAL BUS HUB

(71) Applicants: YI-XIN TU, Shenzhen City (CN); ZHAO-YANG CAI, Shenzhen City (CN); ZHENG-QUAN PENG, Shenzhen City (CN); HAI-QING ZHOU, Shenzhen City (CN)

(72) Inventors: YI-XIN TU, Shenzhen City (CN); ZHAO-YANG CAI, Shenzhen City (CN); ZHENG-QUAN PENG, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/422,137

(22) Filed: Mar. 16, 2012

(30) Foreign Application Priority Data
Dec. 26, 2011 (CN) 201110440358.2

(51) Int. Cl. G06F 1/26

(52) U.S. Cl. 713/340

(57) ABSTRACT

A Universal Serial Bus (USB) hub includes a USB input, a number of USB outputs, a USB controller, a power processing module, and an alarm. The USB controller controls data transmission between a connected USB device connected to the USB output and a computer. The power processing module obtains a power of each USB output and sums the power of all the USB outputs. The power processing module further compares a preset power value with the sum of the power. When the sum of the power is greater than the preset power value, the power processing module outputs a control signal to activate the alarm.

### BACKGROUND

1. Technical Field

The present disclosure relates to a Universal Serial Bus (USB) hub.

2. Description of Related Art

Today, more and more USB devices are used. Therefore, USB hubs are needed to connect the USB devices. However, when a USB hub is used to connect too many USB devices, a USB connector in a computer which is connected to the USB hub may be damaged by excessive power demands.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a USB hub, the USB hub includes a power processing module.

FIG. 2 is a block diagram of the power processing module.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

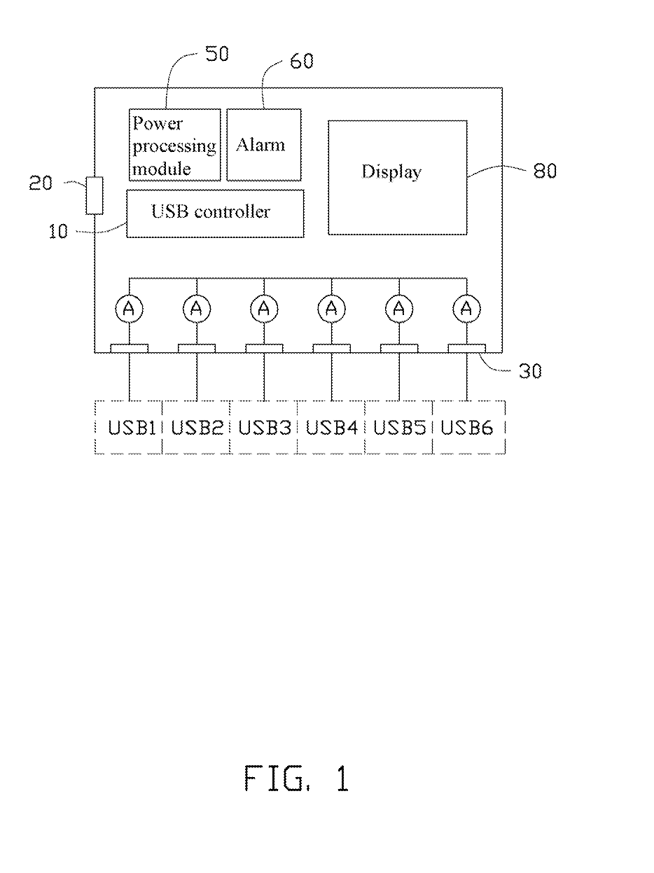

Referring to FIG. 1, an exemplary embodiment of a USB hub includes a USB controller 10, a USB input 20, a plurality of USB outputs 30, a power processing module 50, an alarm 60, and a display 80.

The USB input 20 is a male connector to connect with a USB interface of a computer. The USB outputs 30 are female connectors to connect with a plurality of USB devices (USB1 to USB6 are shown in FIG. 1). The USB controller 10 controls data transmitted between the computer and the USB devices.

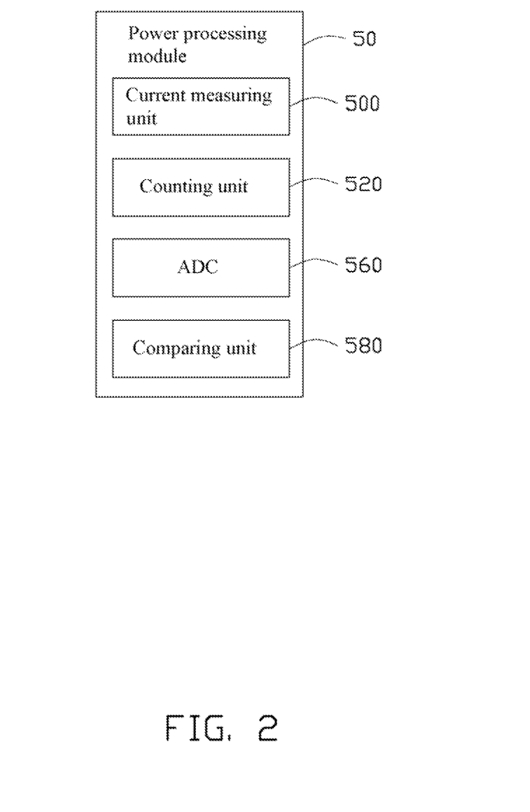

Referring also to FIG. 2, the power processing module 50 includes a plurality of current measuring units 500 (FIG. 2 just shows only one current measuring unit 500), a counting unit 520, an analog-to-digital converter (ADC) 560, and a comparing unit 580. Each current measuring unit 500 measures current flowing through a USB output 30. In the embodiment, the current measuring unit 500 is an ampere meter and connected in series with a power pin of the USB output 30. According to USB standards, a voltage on the USB device is 5 volts (v). As a result, the counting unit 520 multiplies the current measured by each current measuring unit 500 by five to obtain a power of each USB output 30. The counting unit 520 further obtains a sum of all powers of the USB outputs 30, which is equal to a power of the USB hub.

The ADC 560 converts the power of each USB output 30 and the power of the USB hub to digital signals, and transmits the digital signals to the display 80. The display 80 displays the power of each USB output 30 and the power of the USB hub to a user.

The comparing unit 580 stores a preset power value, and compares the preset power value with the power of the USB hub. When the power of the USB hub is greater than the preset power value, the comparing unit 580 outputs a control signal to the alarm 60 to activate the alarm 60 to alert the user with an audio signal or a visual signal.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A Universal Serial Bus (USB) hub comprising:
a USB input to be connected to a USB interface of a computer;
a plurality of USB outputs, wherein each USB output is to be connected to a USB device;
a USB controller to control data transmission between a connected USB device connected to the USB output and the computer when the computer is connected to the USB hub;
a power processing module comprising:
a plurality of current measuring units, wherein each current measuring unit measures current flowing through a USB output;
a counting unit to obtain a power of each USB output and sums the power of all the USB outputs, wherein the power of each USB output is a product of the value of the current flowing through the USB output and five volts; and
a comparing unit to compare a preset power value with the sum of the power; and
an alarm, wherein when the sum of the power is greater than the preset power value, the comparing unit outputs a control signal to activate the alarm.

2. The USB hub of claim 1, further comprising a display, wherein the power processing module comprises an analog-to-digital converter (ADC), the ADC converts the power of each USB output and the sum to digital signals, and transmits the digital signals to the display, the display displays the power of each USB output and the sum.

3. The USB hub of claim 1, wherein each current measuring unit is an ampere meter.
